(19) United States
(12) Patent Application Publication
(10) Pub. No.: US 2019/0122111 A1
(43) Pub. Date: Apr. 25, 2019

(54) Adaptive Convolutional Neural Knowledge Graph Learning System Leveraging Entity Descriptions

(71) Applicant: NEC Laboratories America, Inc., Princeton, NJ (US)

(72) Inventors: Renqiang Min, Princeton, NJ (US); Bing Bai, Princeton Junction, NJ (US); Alexandru Niculescu-Mizil, Plainsboro, NJ (US); Igor Durdanovic, Lawrenceville, NJ (US); Hans Peter Graf, South Amboy, NJ (US)

(21) Appl. No.: 16/168,244

(22) Filed: Oct. 23, 2018

Related U.S. Application Data
(60) Provisional application No. 62/700,945, filed on Jul. 20, 2018.
(60) Provisional application No. 62/576,152, filed on Oct. 24, 2017.

(51) Int. Cl. G06N 3/08; G06N 5/02

(52) U.S. Cl. CPC G06N 3/08; G06N 5/022

(57) ABSTRACT

Systems and methods for predicting new relationships in the knowledge graph, including embedding a partial triplet including a head entity description and a relationship or a tail entity description to produce a separate vector for each of the head, relationship, and tail. The vectors for the head entity, relationship, and tail entity can be combined into a first matrix, and adaptive kernels generated from the entity descriptions can be applied to the matrix through convolutions to produce a second matrix having a different dimension from the first matrix. An activation function can be applied to the second matrix to obtain non-negative feature maps, and max-pooling can be used over the feature maps to get subsamples. A fixed length vector, Z, flattens the subsampling feature maps into a feature vector, and a linear mapping method is used to map the feature vectors into a prediction score.

### RELATED APPLICATION INFORMATION

This application claims priority to 62/576,152, filed on Oct. 24, 2017, incorporated herein by reference in its entirety. This application also claims priority to 62/700,945, filed on Jul. 20, 2018, incorporated herein by reference in its entirety.

### BACKGROUND

### Technical Field

The present invention relates to machine learning using neural networks and more particularly to detecting financial spoofing using neural networks.

### Description of the Related Art

A knowledge graph (KG) stores real world information as a directed multi-relational structured graph. Knowledge graphs express data as a directed graph with labeled edges corresponding to different kinds of relationships between nodes corresponding to entities. A piece of knowledge is represented as a triplet, including a head, relationship, and tail (e.g., (h, l, t) or a head, attribute, and tail (e.g., (h, a, t). For example, Donald Trump is a Politician of USA will be stored as (Donald Trump, isPoliticianOf, USA), where “Donald Trump” is the head entity, “isPoliticianOf” is the relationship, and “USA” is the tail entity. The knowledge graph or knowledge base includes correct triplets (h, l, t), since the information is known, although there can also be mistakes.

In the real world, there are different kinds of knowledge graphs such as WordNet®, Google Knowledge Graph, and DBPedia. WordNet is a large lexical database of English in which words are grouped into cognitive synonyms (synsets) and these synsets are interlinked with different relationships. Google Knowledge Graph is a system that Google® launched to understand facts about people, places and things and how they are connected. DBpedia extracts information from wikipedia as a structured knowledge base.

Web-scale knowledge graphs provide a structured representation of different types of knowledge. The knowledge graphs, however, can be missing entries. Link prediction or knowledge graph completion attempts to predict missing entries. Natural redundancies between recorded relations often make it possible to fill in missing entries of a knowledge graph. Knowledge graph completion can, thereby, find new relational facts.

Inferences between known entries and missing entries have been handled probabilistically and jointly with other facts involving the relations and entities. A tensor factorization method can be applied on the tensor to learn entity and relationship embedding. Embedding involves projecting a knowledge graph into a continuous vector space while preserving certain information of the graph. A bayesian clustered tensor factorization (BCTF) can be applied on the 3-D binary tensor in order to get the balance between clustering and factorizations. A holographic model has been proposed to reduce the time complexity of tensor factorization, in which a novel circular, correlation of vectors is proposed to represent pairs of entities. A neural tensor network (NTN) has been proposed to learn the heads and tails over different relationships. ProjE has been proposed, which uses combination operation and non-linear transformations applied to the triplet and calculates a score for the triplet.

Another group of models such as TransE, TransH, TransR, and TransA, learn low dimensional representations for entities and relationships. TransE, TransH, TransR, and TransA all consider relationships as simple translations between entities and learn embedding based on this assumption. TransE and TransH build entity and relation embeddings by regarding a relation as a translation from head entity to tail entity. TransR builds entity and relation embeddings in separate entity spaces and relation spaces. Embedding symbolic relations and entities into continuous spaces, where relations are approximately linear translations between projected images of entities in the relation space, has been used to represent knowledge graphs. Word embedding is a technique where words or phrases from a vocabulary are mapped to vectors of real numbers. Conceptually it involves a mathematical embedding from a space with one dimension per word to a continuous vector space with a much lower dimension.

An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained in-use, with learning that involves adjustments to weights that exist between the neurons. An ANN is configured for a specific application, such as pattern recognition or data classification, through such a learning process. ANNs demonstrate an ability to derive meaning from complicated or imprecise data and can be used to extract patterns and detect trends that are too complex to be detected by humans or other computer-based systems. Neural Networks can be organized into distinct layers of neurons. Outputs of some neurons can become inputs to other neurons. The structure of a neural network is known generally to have input neurons that provide information to one or more “hidden” neurons.

In deep learning, each level learns to transform its input data into a slightly more abstract and composite representation. A deep learning process can learn which features to optimally place in which level on its own. The “deep” in “deep learning” refers to the number of layers through which the data is transformed. The credit assignment path (CAP) is the chain of transformations from input to output. For a feedforward neural network, where the connections between nodes do not form a cycle, the depth of the CAP is the depth of the network, and is the number of hidden layers plus one for the output layer, which is also parameterized. Convolutional networks are neural networks that use convolution in place of general matrix multiplication in at least one of their layers.

Spoofing is a type of trading operation in which cheating traders enter deceptive orders that attempt to trick the rest of the market into thinking there's more demand to buy or sell than there actually is. The trader attempts to make money by pushing the market up or down in tiny increments, and placing fake “buy” or “sell” orders that are later cancelled. For example, when a cheating trader wants to sell his stock at higher prices, the trader would put fake “buy” orders to influence the market, pushing it to a higher price, then he sells his stocks and cancels his “buy” orders. Similar procedures can be done using “sell” orders to buy stock at a lower price. A spoofing process usually contains three stages: (1) a buildup stage for entering fake buy or sell orders, (2) a cancellation stage to cancel previous fake orders, and (3) a sweep stage to perform intended transactions with large orders.

### SUMMARY

According to an aspect of the present invention, a method is provided for predicting new relationships in the knowledge graph. The method includes embedding a partial triplet including a head entity description and a relationship or a tail entity description to produce a separate vector for each of the head, relationship, and tail; combining the vectors for the head, relationship, and tail into a first matrix; applying kernels generated from entity (head and tail) descriptions to the matrix through convolutions to produce a second matrix having a different dimension from the first matrix; applying an activation function to the second matrix to obtain non-negative feature maps; using max-pooling over the feature maps to get subsamples; generate a fixed length vector, Z, that flattens the subsampling feature map into a feature vector; and using a linear mapping method to map the feature vector into a prediction score.

According to another aspect of the present invention, a system is provided for predicting new relationships in the knowledge graph. The system includes a vector embedding transformer that is configured to embed partial triplets from the head entity description input and the tail entity description input, and combine the vectors for the partial triples into a combined matrix, m2; a matrix conditioner that is configured to generate kernels and apply convolution operations with ReLU over the matrix, m2, to generate feature maps; a pooling agent that is configured to use max-pooling over the feature maps to get subsamples that form subsampling feature maps; a fixed length vector generator that is configured to apply a linear mapping method that flattens the subsampling feature maps into a feature vector, and uses a linear mapping method to map the feature vector into a prediction score; and a convolution kernel filter generator that is configured to generate new weights, and apply the new weights to the fully connected feature map.

According to another aspect of the present invention, a computer readable storage medium comprising a computer readable program for training a neural network to predict new relationships in the knowledge graph, wherein the computer readable program when executed on a computer causes the computer to perform the steps of embedding a partial triplet including a head entity description and a relationship or a tail entity description to produce a separate vector for each of the head, relationship, and tail; combining the vectors for the head, relationship, and tail into a first matrix; applying kernels generated from the entity descriptions to the matrix through convolutions to produce a second matrix having a different dimension from the first matrix; applying an activation function to the second matrix to obtain non-negative feature maps; using max-pooling over the feature maps to get subsamples; generating a fixed length vector, Z, that flattens the subsampling feature maps into a feature vector; and using a linear mapping method to map the feature vector into a prediction score.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a system/method for an adaptive convolutional neural network (ACNN)/system based Knowledge Graph Learning Framework is illustratively depicted in accordance with an embodiment of the present invention;

FIG. 2 is a block/flow diagram illustrating a convolution kernel going over the row of a triplet matrix is illustratively depicted in accordance with one embodiment of the present invention;

FIG. 3 illustratively depicts a system/method for an adaptive convolutional neural network (ACNN)/system based Knowledge Graph Learning Framework in accordance with another embodiment of the present invention.

FIG. 4 is a block/flow diagram illustrating a high-level method for spoof detection, in accordance with one embodiment of the present invention.

FIG. 5 is a block/flow diagram illustrating an ADNN based Knowledge Graph Learning Framework, in accordance with another embodiment of the present invention.

FIG. 6 is a block/flow diagram illustrating a generic ADCNN based Knowledge Graph Learning Framework for application to spoofing detection, in accordance with another embodiment of the present invention;

FIG. 7 is an exemplary processing system 700 to which the present methods and systems may be applied in accordance with another embodiment of the present invention;

FIG. 8 is a block diagram illustratively depicting an exemplary neural network in accordance with another embodiment of the present invention; and

FIG. 9 is an exemplary processing system 900 to which the present methods and systems may be applied in accordance with another embodiment of the present invention.

### DETAILED DESCRIPTION OF PREFERRED EMBODIMENTS

In accordance with the present invention, systems and methods are provided to/for learning more complex connections between entities and relationships. In particular, a Convolutional Neural Network (CNN) or an Adaptive Convolutional Neural Network (ACNN) with adaptive kernel filters generated from entity descriptions (e.g., associated information) can be used to learn entity and relationship representations in knowledge graphs. Entities and relationships can be treated as numerical sequences with the same length. Each triplet of head, relationship, and tail can be combined together as a matrix with a height of 3 and a width of the number of values in the numerical sequence. ACNN is applied to the triplets to get confidence scores. Positive and manually corrupted negative triplets can be used to train the embedding and the ACNN model simultaneously. Entity descriptions can be additional information attached to or associated with (e.g., pop-up information bubble) an entity that can be used to develop additional relationships not expressly identified or provided by the knowledge graph.

In accordance with the present invention, systems and methods are also provided to/for detecting financial spoofing involving fraudulent transactions. Identifying these spoofing transactions in the modem computerized trading era remains a challenging problem. Context-aware machine learning models called adaptive deep (convolutional) neural networks (ADCNN) can be used to identifying these spoofing transactions.

In one embodiment, a convolutional neural network (CNN) is used to learn the entity and relationship embedding and their connections. An Adaptive Convolutional Neural network (ACNN) with generated convolutional filters tailored to specific entity attributes (descriptions) can be used to learn sequential representations and high level non-linear connections between entities and relationships, which is different from neural tensor networks (NTN) and ProjE.

In one or more embodiments, knowledge graph completion (KGC) methods are provided to find missing or incorrect relationships in knowledge graphs (KG).

In one or more embodiments, a CNN or an ACNN model, adaptive filters and convolution operations are used to exploit local features and high level features. Because of the advantages of ACNN in learning features, an ACNN model is applied to the combined matrix to learn entity and relationship representations and their complex connections by exploiting the connection structure within the triplet (h, l, t) simultaneously. A confidence score is learned as the output of the ACNN model with a logistic unit. The existing triplets are used as positive samples and to create negative samples by corrupting positive triplets to train the ACNN models. After the ACNN model is learned, a score for each triplet in the test data can be learned. New relationships in the knowledge graph can be predicted based on the scores of the triplets.

Much better performance can be achieved with the ACNN than other competing approaches for exploring unseen relationships and performing knowledge graph completion, which can be used to improve the system performance for many natural language processing applications such as sentence classification, sentiment analysis, question answering, and sentence reasoning.

In another embodiment, a generic and adaptive weight generation or convolutional filter generation mechanism can be used for automatic spoofing detection employing a deep neural network (DNN) or deep convolutional neural network (DCNN). In contrast to traditional DNNs/CNNs, the weight parameters or the convolutional filters in this framework are not fixed, and thus endows the neural networks with stronger modeling flexibility/capacity.

In various embodiments, a meta network is introduced to generate a set of connection weights or input-aware filters, conditioned on the specific input feature vectors of the transactions such as what fraction of the demand that would be fulfilled before the order, how much is the transaction price higher (lower) than the trading price, etc., and these weights/filters are adaptively applied to the same or a different input feature vector. In this manner, the produced weights/filters vary from transaction to transaction and are able to allow more fine-grained feature abstraction for spoofing identification. Besides, the meta (filter generating) networks can be learned end-to-end together with other network modules during the training procedure. In contrast, previous methods are simply rule based.

This architecture can not only generate highly effective weights/convolutional filters for the input feature vectors of transactions, it can also serve as a bridge to allow interactions between additional transaction side information and automatically generated transaction feature vectors. These Adaptive DNNs/DCNNs produce much better performance than other competing approaches for knowledge graph completion and financial spoofing detection, and they are flexible to leverage the interactions between additional transaction side information and automatically generated transaction feature vectors to further improve prediction performance.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention may be a system, a method, and/or a computer program product. The computer program product may include a computer readable storage medium (or media) having computer readable program instructions thereon for causing a processor to carry out aspects of the present invention.

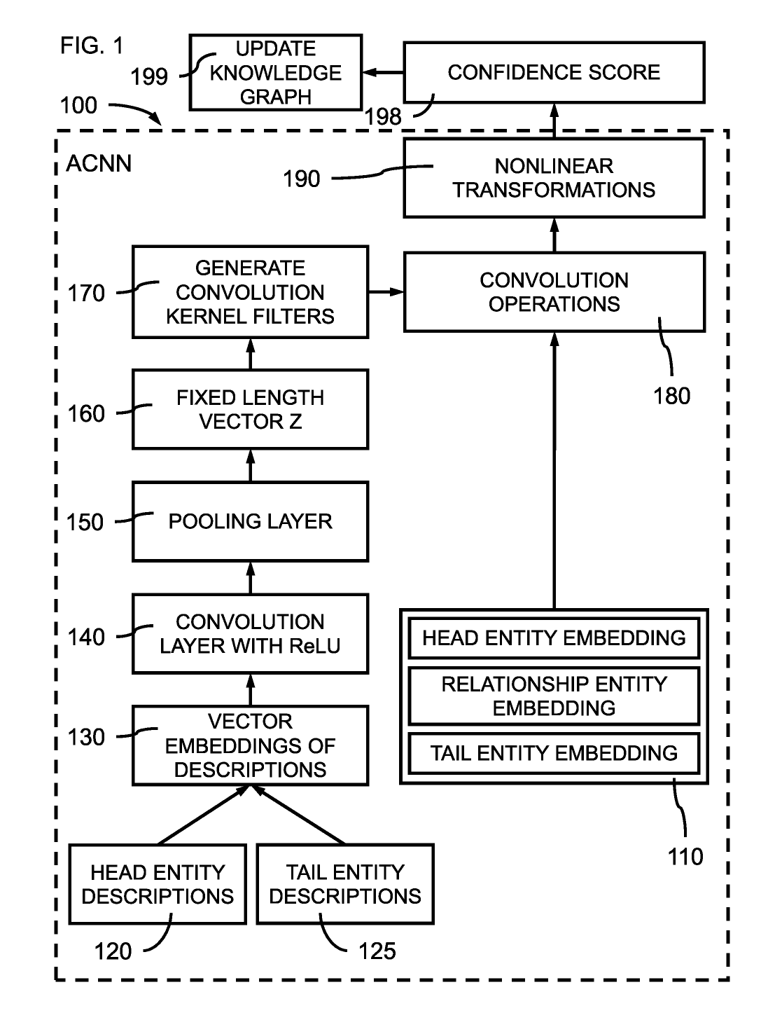

Referring now in detail to the figures in which like numerals represent the same or similar elements and initially to FIG. 1, a system/method for an adaptive convolutional neural network (ACNN)/system based Knowledge Graph Learning Framework is illustratively depicted in accordance with an embodiment of the present invention.

Usually, knowledge graphs suffer from incompleteness. People try to exploit new triplets based on the existing incomplete graph: (1) given a head or tail and one kind of relationship, l, find the associated tail or head, (h, t), in the entity set; (2) given one head, h, and one tail, t, find the relationship, l, between these two entities.

The drawback of some models is that the translation structure assumption between entities and relationships is simple but in reality the connections between entities and relationships are more complex. An Adaptive Convolutional Neural Network (ACNN) with adaptive kernel filters generated from entity descriptions can be used to learn entity and relationship representations in knowledge graphs. Entities and relationships can be treated as one-dimensional numerical sequences where all numerical sequences can have the same length. In a CNN model, entities and relationships are represented as low-dimensional sequential vectors. Each triplet (h, l, t) can be treated as one instance and combine head, relationship and tail sequential vectors together to create a matrix with height 3. The CNN model can then be used on this combination matrix to learn the entity and relationship representations and exploit the connection structure within h, l, and t simultaneously. A confidence score can be learned as the output of the CNN model with a logistic unit. The existing triplets can be used as positive samples and to create negative samples by corrupting positive triplets to train the CNN models. After the CNN model is trained, a score can be learned for each triplet in the test data.

A convolutional neural network (CNN) can be used to learn the entity and relationship embedding and their connections. The CNN model can then be used on this combination matrix to learn the entity and relationship representations and exploit the connection structure within h, l, and t simultaneously. Existing known triplets can be used as positive samples, and negative samples can be created by corrupting positive triplets to train the CNN models. Positive triplets (h, l, t) can have a small distance between h+l and t while negative triplets (h′, l, t′) will have big distance between h′+l and t′. The relationship between two entities corresponds to a translation between the embeddings of entities, that is, h+l+=t when the relation between (h, l, t) is true, and the translation for h+l+t for (h′, l, t′).

The adaptive convolutional neural network can produce much better performance than other competing approaches for knowledge graph completion, which can be applied to spoofing detection, natural language processing applications, sentiment analysis, automated question answering and reasoning.

In block 110, known triplets (h, l, t) are embedded by translating the head, relationship, and tail into sequential vectors in a continuous low-dimensional vector space. The entities, e, and relationships, l, are represented as one-dimensional numerical sequences.

In various embodiments, a CNN based model can learn entity and relationship representations, where entities, e, are an element of a set E (e ϵ E), and relationships, l, are an element of a set L (l ϵ L). The entities, e, and relationships, l, can be represented as sequential vectors in a low-dimensional embedding space: e, l ϵ [symbol] ^{k} where [symbol] is the embedding space and k is the embedding dimension or model hyperparameter.

A knowledge graph (KG) is constructed from a set of entities E and a set of relations L. Thereby, given one triplet (h, l, t), if the relationship of h⇒t for l, is true, a positive value of 1 is assigned to the triplet, otherwise a value of 0 is assigned to the triplet. Positive and negative training triplets can be used together to learn entity and relationship embedding and score a function jointly, where a score function maps the raw data to class scores. The designed score function ƒ should give positive triplets (h, l, t) high scores and give negative triplets (h′, l, t), (h, l, t′) low scores, where the prime, ′, indicates an incorrect entity for the relation.

Given a positive training Set, S, of triplets in one knowledge graph, a negative training Set, S′, can be created by randomly replacing a head or a tail (but not both at the same time), such that S′_{(h, l, t)}={(h′, l, t)|h′ϵE}∪{(h, l, t′)|t′ϵE}.

In various embodiments, a Convolutional Neural Network can be used as the score function to learn embedding and scores. In the CNN based Knowledge Graph model, both embedding and CNN based score function are unknown. The CNN model learns entity and relationship representations simultaneously.

In block 110, given a triplet (h, l, t), the three vectors are combined together as a matrix, m1ϵ [symbol] ^{3×k}, where ^{3×k} is the dimension of the space [symbol] . 3 represents the three vectors for the triplet, and k is the dimension of the vectors. Since the matrix includes the vectors for the head entity, tail entity, and relationship, the matrix can have a height of 3. The CNN model is applied on the matrix and a score can be assigned to the triplet.

In block 120, head entity descriptions associated with the head entity of the triplet(s) used in block 110 can be identified from the knowledge graph and incorporated into the CNN. The head entity descriptions can be used to create one or more combinations of triplets containing the identified head entity and a relationship with an unknown tail entity or an unknown relationship with a known tail entity. This can be a partial triple (h, l, ?) or (h, ?, t), where assignment of an entity as a head or a tail may be arbitrary. The partial triple can be provided as input to the CNN and an associated entity to complete the triplet can be identified as an output. In various instances, the entity descriptions can be non-discriminative, so cannot be used to identify new relationships.

In various embodiments, entity descriptions for head entities can be incorporated from a knowledge graph resource, for example, the words of a Wikipedia® page entry can be obtained from Wikipedia® or DBpedia. In a knowledge graph, entity descriptions can be easily collected. The entity descriptions can be used to improve the model performance. DBpedia extracts structured content from the information created in various Wikimedia projects, where the structured information resembles a knowledge graph (KG). The DBpedia knowledge base describes things, including persons, places, creative works, including music albums, films and video games, organizations, including companies and educational institutions, species and diseases. The entity representations are learned from the entity descriptions directly by using an encoding model. Not all of the described things from Wikipedia® or DBpedia are connected through a relationship. Knowledge graph completion aims at predicting previously unidentified relations between entities of the existing knowledge graph. By learning the ACNN and applying the learned model to the initially unrelated entities in Wikipedia® or DBpedia new relationships can be recognized and used to fill in missing parts to the knowledge graph.

In block 125, tail entity descriptions associated with the tail entity of the triplet(s) used in block 110 can be identified from the knowledge graph and incorporated into the CNN. The tail entity descriptions can be used to create one or more combinations of triplets containing the identified tail entity and a relationship with an unknown head entity or an unknown relationship with a known head entity. This can be a partial triple (?, l, t), where assignment of an entity as a head or a tail may be arbitrary. The partial triple can be provided as input to the CNN and an associated entity to complete the triplet can be identified as an output. In various embodiments, entity descriptions for tail entities can be incorporated from a knowledge graph resource, for example, the words of a Wikipedia® page entry can be obtained from Wikipedia®. The entity representations are learned from the entity descriptions directly by using an encoding model.

In one or more embodiments, the descriptions obtained from Wikipedia® or DBpedia can be filtered to extract keywords that can then be embedded.

In block 130, the partial triples identified in blocks 120 and/or 125 can be embedded as vectors for subsequent operations. The vectors for the partial triples can be combined into a combined matrix, m2. m2ϵ [symbol] ^{3×k}, where ^{3×k} is the dimension of the space [symbol] . 3 represents the three vectors for the triplet, and k is the dimension of the vectors. Since the matrix includes the vectors for the head entity, tail entity, and relationship, the matrix can have a height of 3. The parameters of the kernels can be learned through training the system without having them directly from the triplets. New kernels can be generated for the entity descriptions.

In one or more embodiments, the relationship description can be obtained from DBpedia and embedded as a 5-dimensional vector (e.g., 5×1), where the head description can be embedded as a 5-dimensional vector, and the tail description can be embedded as a 5-dimensional vector. The relationship, l, also can be embedded as a 5-dimension vector that captures the relationship between two entities (e.g., h, t), so the vector for h plus the vector for l minus the vector for t≈0, (Vₕ+Vₗ−Vₜ≈0). Prediction attempts to determine the likelihood that a relationship between entities is true, when the information is not expressly provided. The embeddings (5-dimensional vectors) may be learned.

In block 140, a convolution operation with ReLU can be initiated over the matrix, m. Multiple 3×3 kernels can be used to do convolution operations over the combined matrix, m, where each of the multiple 3×3 kernels can provide a different filtering operation on the combined matrix. Since the height of m is 3, kernels with the same height, g, as the input matrix are used. As a result, the convolution operation will only go over the row of matrix, m. This is different from CNN kernels on images that go through rows and columns on an image matrix. Different weights can be used for the kernels for specific convolutions. Kernels can be generated from the entity descriptions.

In one or more embodiments, locally connected structures over the head, relationship, tail can be explored together. In various embodiments, the kernel number (kernel channel) is c, for the matrix m, then c feature maps with a size 1×(k−g+1) can be generated. The Rectified Linear Unit (ReLU) activation function, ReLU (x)=max (0, x) can be applied to get non-negative feature maps by zeroing out negative values of x. The ReLU function f(x)=max(0,x) sets the activation threshold at zero, where ReLU is a linear, non-saturating form of activation function. Max (0, x) is the max function.

Relation types can be represented by latent feature vectors and/or matrices and/or third-order tensors.

In block 150, after the convolution operation, max-pooling can be used over the feature maps to get subsamples. The size of the max pooling filter can be set as (1×2) and the stride as 2. As a result, smaller feature maps with a length of ((k−g+1)−1)/2+1 can be obtained, which is equal to (k−g)/2+1. The pooling function can be used to reduce the dimensions of the output from the dot product of the convolution matrix on the matrix, m, to obtain a feature map with a predetermined set of dimensions. The pooling process can provide subsamples from the output of the convolution operation in block 140.

In block 160, a fixed length vector, Z, can be generated, where the subsampling feature maps can be flattened into a one-dimensional feature vector, ƒ_{flat}.

In a full connection step, the subsampling feature maps can be flattened into one feature vector, ƒ_{flat}, with size c×((k−g)/2+1). A linear mapping method can be used to map the feature vector, ƒ_{flat}, into a new fully connected feature, ƒ_{fc1}, where ƒ_{fc1}=ƒ_{flat} W_{flat}+b_{flat}, where W_{flat} is the linear mapping weight, and b_{flat} is the bias that need to be learned. Max pooling and dropout can be used on ƒ_{fc1} to get a new fully connected feature map, ƒ_{fc2}. ƒ_{fc1} to ƒ_{fc2}, can be performed by matrix transforms.

In various embodiments, the fully connected layer can be, for example, a 500×1 vector. The vector can be formed through concatenation of other vectors.

In block 170, new convolution filters or newly generated weights can be applied to the fully connected feature map.

In various embodiments, logistic regression can be applied (e.g., binary logistic regression classifier) to the fully connected feature map, ƒ_{fc2}, to obtain classification of the relationship for the original partial triplets.

The fully connected feature, ƒ_{fc2}, after max pooling and drop out can be used as the final high level feature. A positive triplet has a score of 1, while a negative triplet has a score of 0. It is proper to use logistic regression to calculate scores with a range (0, 1) for every triplet. The final score function on ƒ_{fc2} can be score (h, l, t)=sigmoid (ƒ_{fc2} W_{fc2}+b_{fc2}), where W_{fc2} is a matrix of weights, and b_{fc2} is the basis vector for the fully connected feature. The matrix, W_{fc2}, and the basis vector, b_{fc2}, are the parameters of the function. The values of W_{fc2} and b_{fc2} can be set in such way that the computed scores match the known relationship labels across a whole training set. Each row of W_{fc2} is a classifier. The sigmoid activation function can output a value between 0 and 1. The matrix of weights and the basis vector influence the output scores without affecting the input data. Once the learning is complete, the training set can be discarded, and the learned parameters can be retained for application on the embedded entities through matrix, W_{fc2}, and the basis vector, b_{fc2}.

In block 180, convolution operations can be applied to the known head, relationship, tail triplets, (h, l, t). Kernels can be applied to the triplets, (h, l, t) as applied to the partial triplet (h, l, ?) or (?, l, t) or (h, ?, t). The same generated kernels may be applied to both the known triplets and the partial triplets, or new kernels may be generated for the known triplets, (h, l, t).

In block 190, non-linear transforms can be applied, where a loss function can be utilized in producing an output score, where the loss function quantifies the agreement between the predicted scores and a true label.

CNN (h, l, t) can be used to produce the output score of a proposed CNN model, where training the CNN model can be treated as a pairwise ranking problem where one positive triplet should have a higher score than the negative triplets constructed according to S′_{(h, l, t)}={(h′, l, t)|h′ϵE}∪{(h, l, t′)t′ϵE}. A marginal ranking loss function can be used to learn the model, where the loss function can be minimized with respect to the parameters of the score function, as an optimization problem. A loss function can be Σ_{(h,l,t)ϵS}Σ_{(h′,l,t′)ϵS′}[γ+cnn(h′, l, t′)−cnn(h, l, t)]+, where [ ]+=max (0, 1), and γ is a hyper-parameter of the ranking loss (e.g., margin hyperparameter). In various embodiments, the default value of γ can be set to 1. (h′, l, t′) is an incorrect triplet generated from the correct known triplet (h, l, t), where h′ and/or t′ makes l not true for (h, l, t).

In block 198, confidences scores are calculated for the output.

In block 199, newly identified relationships can be incorporated back into a knowledge graph to improve the knowledge graph. The confidence scores can be used to find missing or incorrect relationships in knowledge graphs by identifying the most probable triplets, (h, l, t), which can be added into the knowledge graph to advance the knowledge graph completion.

In one or more embodiments, two sets of parameters can be learned: (1) the entity and relationship embedding in E and L; and (2) the CNN parameters set, Φ_{CNN} including the parameters of c for the convolutional kernels with size 3×3, fully connected mapping parameters, W_{flat} and b_{flat}, and logistic regression parameters, W_{fc2} and b_{fc2}. To learn parameters and optimize the loss function in Σ_{(h,l,t)ϵS}Σ_{(h′,l,t′)ϵS′}[γ+cnn(h′,l,t′)−cnn(h, l, t)]+, a mini-batch stochastic gradient descent method can be used.

The training batch samples can be generated as follows: the batch size can be set as b, where b positive triplets are randomly chosen from the positive training set, S, then for every positive triplet, a negative triplet is generated using S′_{(h, l, t)}={(h′, l, t)|h′ϵE}∪{(h, l, t′)|t′ϵE}. It should be pointed out that when constructing negative samples, we can corrupt one positive triplet by randomly replacing its head or tail. However, since the training triplets in the knowledge graph are not complete, some constructed “negative” triplets may hold. As a result, these false negative triplets will be noise when training.

In a real knowledge graph, there are different kinds of relationships: one-to-many, many-to-one, or many-to-many. When corrupting one triplet, different probabilities for replacing head or tail entity can be set in order to reduce the chance of generating false negative triplets or create negative samples.

In various embodiments, there are b pairs of positive and negative triplets in a batch. The loss function for these b pairs of positive and negative triplets in the batch can be minimized. The embedding and the CNN model parameters can be initialized to random initial values. At each main iteration, multiple batches are created and used as training data, mini-batch stochastic gradient descent method is used to update all the parameters. The algorithm is stopped by using a fixed main iteration number.

For various embodiments, the details are in Algorithm 1, Learning Knowledge Graph Embedding with CNN Model:

Input: training Set, S=(h, l, t), entity and relationship set E and L, margin γ, embedding dimension k;

Randomly Initialize: e, l.

Loop: for batch=1: batch_num;

1. S_{batch}←sample(S,b), construct negative triplets S′_{batch}

2. Calculate gradient ∇ [symbol] _{batch} of Σ_{(h,l,t)ϵS}Σ_{(h′,l,t′)ϵS′}[γ+cnn(h′,l,t′)−cnn(h, l, t)]₊, w.r.t. S_{batch} and S′_{batch}

3. Update embedding and ψ_{CNN} w.r.t. ∇ [symbol] _{batch}

end for

end loop

In various embodiments, two public datasets which are widely used in knowledge graph learning models: FB15K and WN18 can be used to conduct experiments on the CNN. FB15K is created based on Google Knowledge Graph Freebase dataset. This dataset contains various entities such as people, places, events and so on, it also contains thousands of relationships. WN18 is generated from WordNet. The statistical details including entity and relationship numbers, triplet size in training, validation and testing set are shown in table 1.

| | Mean Rank | Hits at 10% |
|---|---|---|
| FB15K | | |
| TransE | 125 | 47.1 |
| TransH | 87 | 64.4 |
| TransR | 77 | 68.7 |
| PTransE | 58 | 84.6 |
| ProjE | 34 | 88.4 |
| CNN | 68 | 94.5 |
| WN18 | | |
| TransE | 251 | 89.2 |
| TransH | 303 | 86.7 |
| TransR | 225 | 92.0 |
| PTransE | — | — |
| ProjE | 235 | 95 |
| CNN | 17 | 96.2 |

Entity prediction on FB15K and WN18.

In various embodiments, the width of convolutional kernels with different sizes can be fixed at a kernel size of 3×3. γ can be set to 1, when using pairwise ranking loss to learn CNN.

We use two evaluate metrics. For each test triplet, we corrupt the head by using other entities in the entity set E in turn and calculate the scores for the test triplet and all the corrupted triplets. After that we rank these triplets with their scores by descending order. Finally we get the ranking of correct entity. If the ranking of the correct entity is smaller or equal 10, Hit@10 for the test triplet is equal to 1, or it will be 0. For all the triplets in the testing data, we report the same procedure and get the Mean Rank scores and mean value Hits @10. We will also replace tails of the triplets and calculate the Mean Rank and Hits @10. We report the average scores on head prediction and tail prediction as final evaluation results.

When constructing corrupted triplets, some of them may hold in training or validation set. We will remove from the list first and then use the filtered triplets to get the two evaluation results.

From the Table, it can be seen that on FB15K, the CNN can achieve 94.5 on Hits art 10%, which is much better than the other methods. The CNN approach can achieve more than 90 in all the models.

In various embodiments, convolutional kernels can be used on knowledge graph triplets to learn complex connections between entities and relationships. In various embodiments, a simpler multilayer perceptron (MLP) model can be used directly without convolutional kernels and learn embedding: first of all the k dimensional h, l and t can be connected together as a 3k dimension vector, after that a hidden layer can be used with tanh activation function to get a new vector having values between −1 and 1. Finally, logistic regression is applied on the hidden layer nodes to get a score. The learning algorithm is similar to the proposed model. The same approach is used to get negative samples and also use mini-batch gradient descent method to learn the regression model. For both datasets. The embedding dimensions are selected from {50, 100, 200} and hidden dimensions are selected from {128, 256, 512}. For FB15K, embedding dimension is set at 200, and the hidden dimension is set at 128.

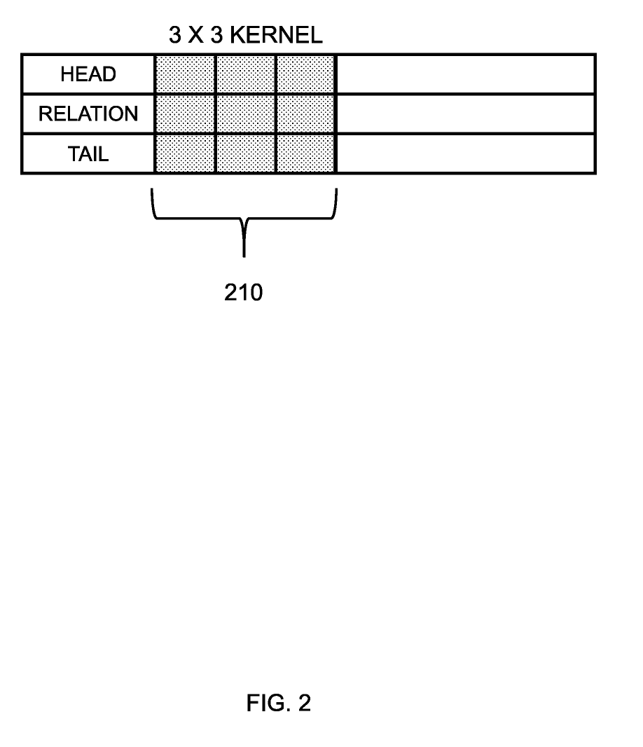

In FIG. 2 a block/flow diagram illustrating a convolution kernel going over the row of a triplet matrix is illustratively depicted in accordance with one embodiment of the present invention.

In block 210, convolutional kernels for use on the knowledge graph triplets are illustrated. In various embodiments, the width of convolutional kernels can be set to different sizes. In various embodiments, the kernel size can be 3×3, where the kernel can be a multidimensional array of parameters that are adapted by a learning algorithm. The kernel can be referred to as a tensor.

In various embodiments, each member of the kernel is shifted over the values of the input vectors, so each member of the kernel is used at every position of the input. For example, with a 3×3 kernel, the tensor values are applied to three input values of each the head, relation, and tail vectors, and then shifted (i.e., convolve) to apply to a different set of the values for the head, relation, and tail vectors to produce activation maps. The shift parameter can be 1, or an integer greater than 1 that does not result in a non-interger number of steps.

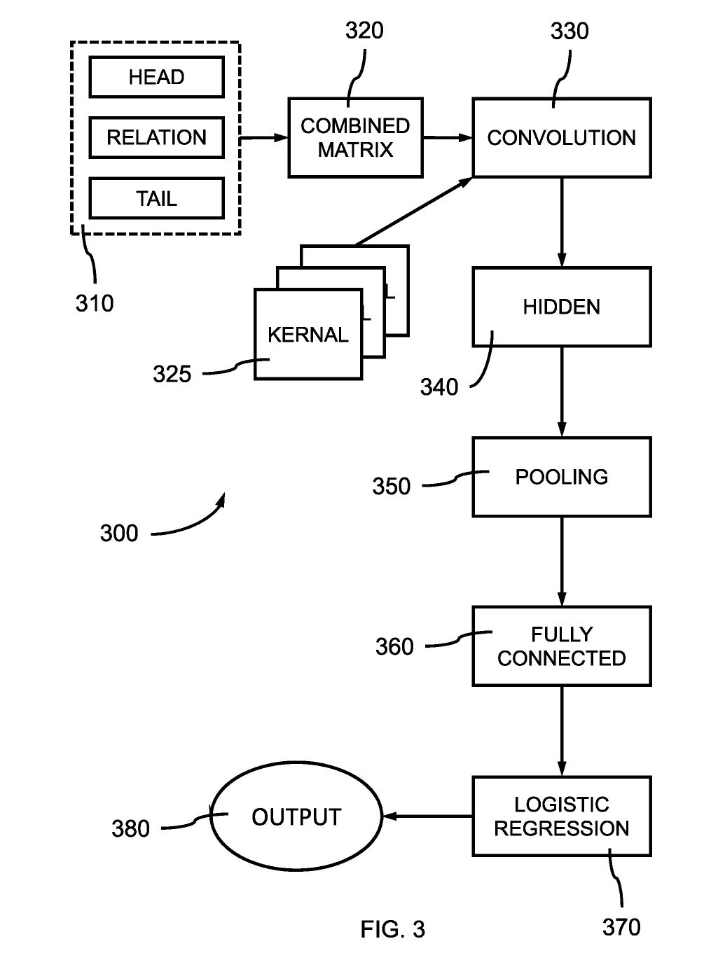

In FIG. 3 a system/method for an adaptive convolutional neural network (ACNN)/system based Knowledge Graph Learning Framework is illustratively depicted in accordance with another embodiment of the present invention.

In one or more embodiments, a generic and adaptive convolutional neural network (ACNN) framework provides for learning the embedding of entities and relationships in knowledge graphs, by introducing a meta network to generate the filter parameters from entity descriptions. In various embodiments, a two-way meta network can generate entity description dependent filter parameters of the CNNs, and be applied to a sequential representation of a head entity, relationship, and tail entity for knowledge graph learning and completion. A partial triplet (h, l, ?) or (?, l, t), where assignment of an entity as a head or a tail may be arbitrary, can be provided as input and an associated entity to complete the triplet can be provided as an output. A relationship prediction task aims to find a relationship for an incomplete triplet, (h, ?, t), that connect a head-entity with a tail-entity, where the ? represents an unknown entity or relationship.

In block 310, a training set including a plurality of triplets having known head, relation, and tail, (h, l, t) can be embedded to train the ACNN.

In block 320, the vectors for the head, relationship, and tail can be combined to form a matrix.

In block 325, one or more kernels can be generated to operate on the matrix of block 320.

In block 330, the kernel(s) generated in block 325 can be applied to the combined matrix through convolution.

In block 340, additional hidden layers can be applied to the feature map output by convolution. In various embodiments, there can be one or more hidden layers depending on the task. The number of hidden layers for a classification can depend on experiments.

In block 350, a pooling layer can be applied to the feature maps, where the pooling can be max pooling or average pooling depending on the input and feature map.

In block 360, a fully connected layer can be generated to reduce the dimension of the output from the pooling layer, and provide classification of the input.

In block 370 logistic regression can be applied to the output from the fully connected layer to learn the neural network.

In block 380, the final output can be provided to a user for use of newly identified relationships or classified transactions.

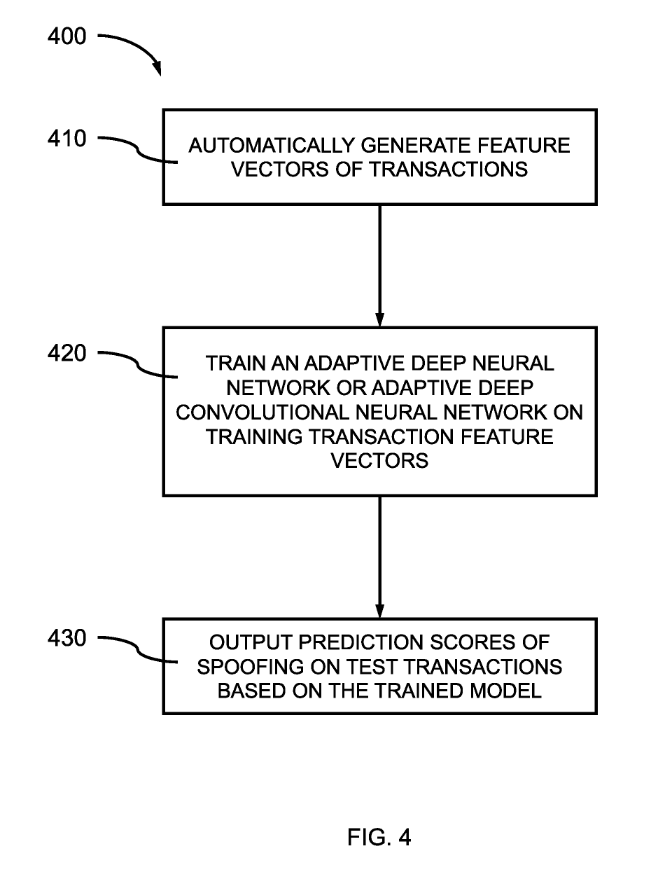

In FIG. 4 a system/method for a high-level method for spoof detection is illustratively depicted in accordance with one embodiment of the present invention.

In one embodiment, a method 400 of using a feature vector representation for a transaction, employing a deep learning model, and adopting meta-networks to generate network parameters/convolutional filters is provided.

In block 410, a feature vector representation is generated for a plurality of transactions, where the feature vector can represent a fraction of the demand that would be fulfilled before an order is placed for buy orders, sell orders and cancelled orders, how much higher or lower the transaction price is than the present trading price of the item (e.g., stock, bond, commodity) listed in the order. Additional information can be included in the vector representation.

In block 420, the adaptive deep neural network (ADNN) or adaptive deep convolutional neural network (ADCNN) can be trained using the transactional feature vectors, where the ADNN or ADCNN develops a recognition of fraudulent orders through the training. The transactional feature vectors can influence one or more weight value(s) in training the ADNN or ADCNN model to recognize fraudulent transactions in comparison to non-fraudulent transactions through the transaction patterns.

The ADNN or ADCNN can learn to predict whether a placed buy or sell order is likely fraudulent based on the timing, frequency of occurrences, current trading price, influence of the buy or sell order on the price change, and the likelihood of the order being cancelled in view of similar orders and the previously learned patterns.

In block 430, the ADNN or ADCNN calculates prediction scores of the likelihood of spoofing for test transactions utilizing the trained model. Applying the model to predict the likelihood of the order being fraudulent, a prediction score can be calculated for actual transactions.

In various embodiments, a placed order can be denied, cancelled, or otherwise nullified to prevent the order from influencing a price upward or downward. Conversely, an order identified as fraudulent with high probability may be prevent from being subsequently cancelled to preserve the actual influence on modified prices. The sock, bond, or commodity trading system may be sent a communication signal that alerts the trading system to the fraudulent activities and spoofing. The trading system can then act on the received communication by denying the order before it can affect a trading price, cancel the order to correct the trading price, or lock in the order to actualize the trading price at the trading desk/floor.

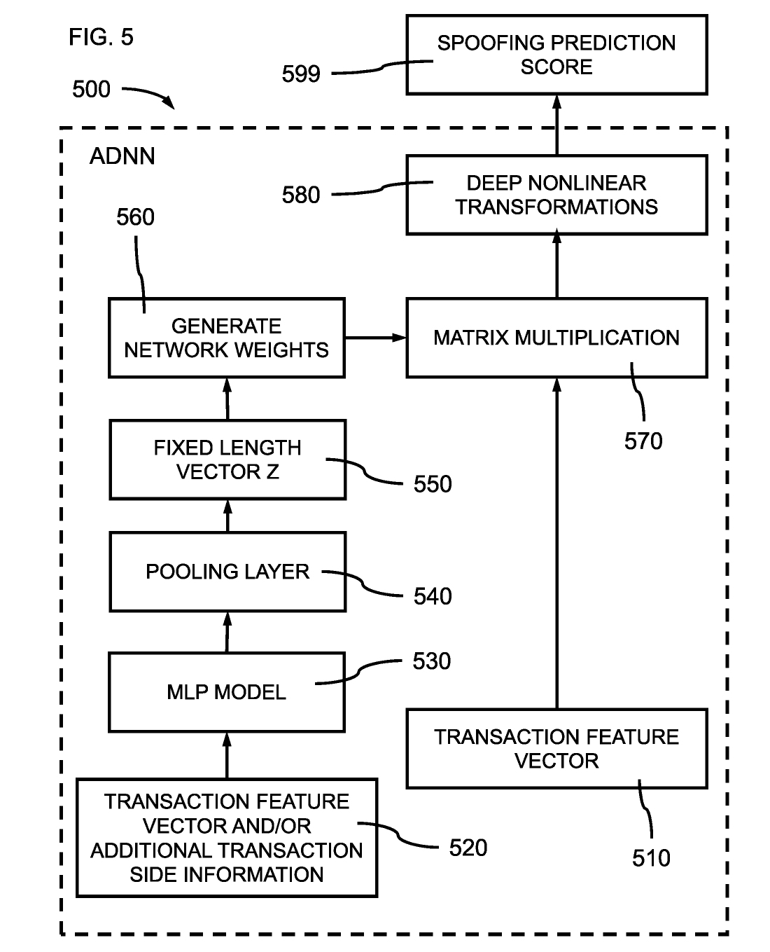

In FIG. 5 a system/method 500 for adaptive deep neural network/system is illustratively depicted in accordance with another embodiment of the present invention.

In block 510, transaction feature vectors can be embedded based on known relationships between trade orders, pricing, timing, cancellation, and completion. The dimension of the vectors can depend on the number of values and relationships.

In block 520, partial transactions can be embedded for incomplete transactions to predict the likelihood that the transaction is a spoof.

In block 530, an MLP consists of, at least, three layers of nodes: an input layer, a hidden layer and an output layer. The MLP can include one or more hidden layers depending on the outcome of experiments. MLP utilizes backpropagation for training. The embedded transactions can be input into the MLP to classify the incomplete transaction as spoofing or authentic.

Deep learning is a class of machine learning algorithms that uses a cascade of multiple layers of nonlinear processing units (perceptrons) for feature extraction and transformation. Each successive layer uses the output from the previous layer as input. learn multiple levels of representations that correspond to different levels of abstraction; the levels form a hierarchy of concepts

The ReLU activation can involve one or more ReLU activation layers on top of (subsequent to) the MLP. The input layers to the MLP can be linear, and the subsequent hidden layers can be non-linear.

Entity descriptions are incorporated into entity embedding.

Block 540 corresponds to block 150 of FIG. 1, where a pooling layer can be applied to feature maps.

Block 550 corresponds to block 160 of FIG. 1, where the subsampling feature maps can be flattened into a feature vector.

Block 560 corresponds to block 170 of FIG. 1 where networks weights can be generated and applied to the fully connected feature map.

Block 570 corresponds to block 180 of FIG. 1, where a convolution operation can be applied.

Block 580 corresponds to block 190 of FIG. 1, where deep non-linear transforms can be applied, where a loss function can be utilized in producing an output score, where the loss function quantifies the agreement between the predicted scores and a true label.

Block 599 corresponds to block 198, where a spoofing prediction score can be output to identify the likelihood that a partial transaction input at block 520 constitutes a spoofed transaction that is expected to be cancelled after having a desired effect on the price of a traded item (e.g., stock, bond, commodity, etc.).

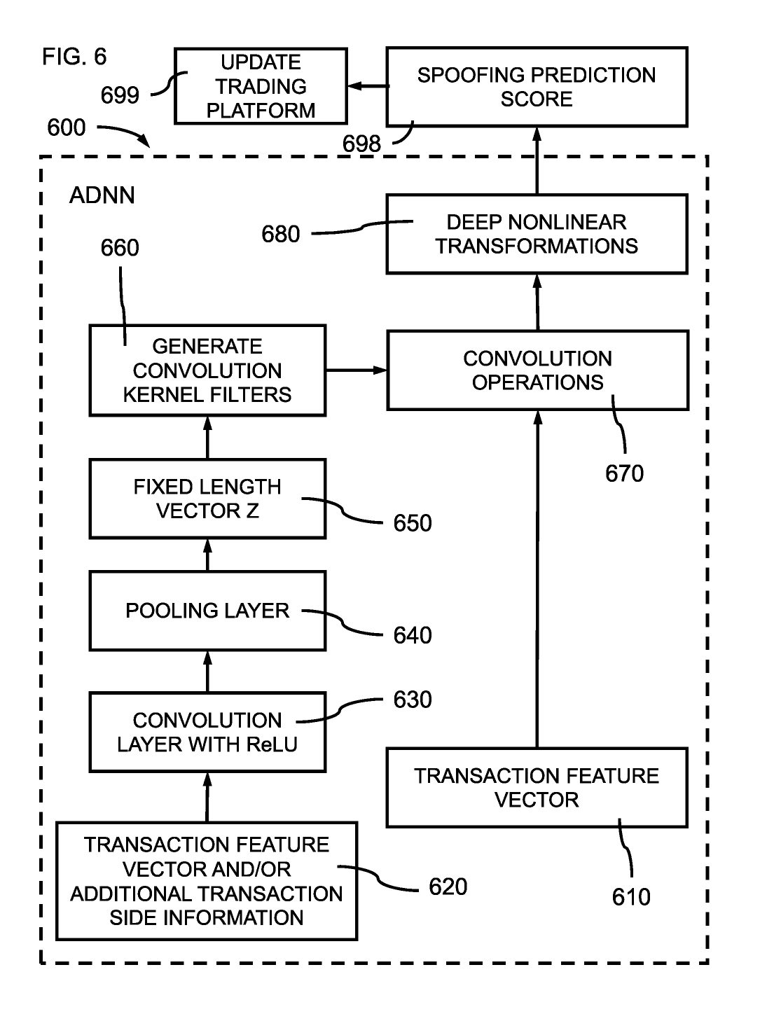

FIG. 6 is a block/flow diagram illustrating a generic ADCNN based Knowledge Graph Learning Framework for application to spoofing detection, in accordance with another embodiment of the present invention.

In FIG. 6, the features described for FIG. 1 and FIG. 2 can be applied as method 600 to spoofing detection, where block 610 corresponds to block 110 to embed known transactions as vectors.

Block 620 corresponds to blocks 120, 125, and 130 where partial transactions and additional information can be embedded into transaction feature vectors having a predefined dimension.

Block 630 corresponds to block 140, where convolution and ReLU is applied to the transaction feature vectors.

Block 640 corresponds to block 150, where max-pooling can be used over the feature maps to get subsamples.

Block 650 corresponds to block 160, where a fixed length vector, Z, can be generated, where the subsampling feature maps can be flattened into a one-dimensional feature vector.

Block 660 corresponds to block 170, where new convolution filters or newly generated weights can be applied to the fully connected feature map.

Block 670 corresponds to block 180, where convolution operations can be applied to the known transactions.

Block 680 corresponds to block 190, where non-linear transforms can be applied, where a loss function can be utilized in producing an output score, where the loss function quantifies the agreement between the predicted scores and a true label.

Block 698 corresponds to block 198, where a spoofing prediction score can be output to identify the likelihood that a partial transaction input at block 620 constitutes a spoofed transaction that is expected to be cancelled after having a desired effect on the price of a traded item (e.g., stock, bond, commodity, etc.).

Block 699 corresponds to block 199, where the spoofing scores can be used to identifying the most probable spoofing relationships on a trading platform and interrupt, cancel, or lock in the trade orders to maintain the integrity of the trading platform (e.g., stock exchanges, commodity exchanges, etc).

In various embodiments, a placed order can be denied, cancelled, or otherwise nullified to prevent the order from influencing a price upward or downward based on the spoofing prediction score. An order identified as fraudulent with high probability may be prevent from being subsequently cancelled to preserve the actual influence on modified prices. The stock, bond, or commodity trading system may be sent a communication signal that alerts the trading system to the fraudulent activities and spoofing. The trading system can then act on the received communication by denying the order before it can affect a trading price, cancel the order to correct the trading price, or lock in the order to actualize the trading price at the trading desk/floor.

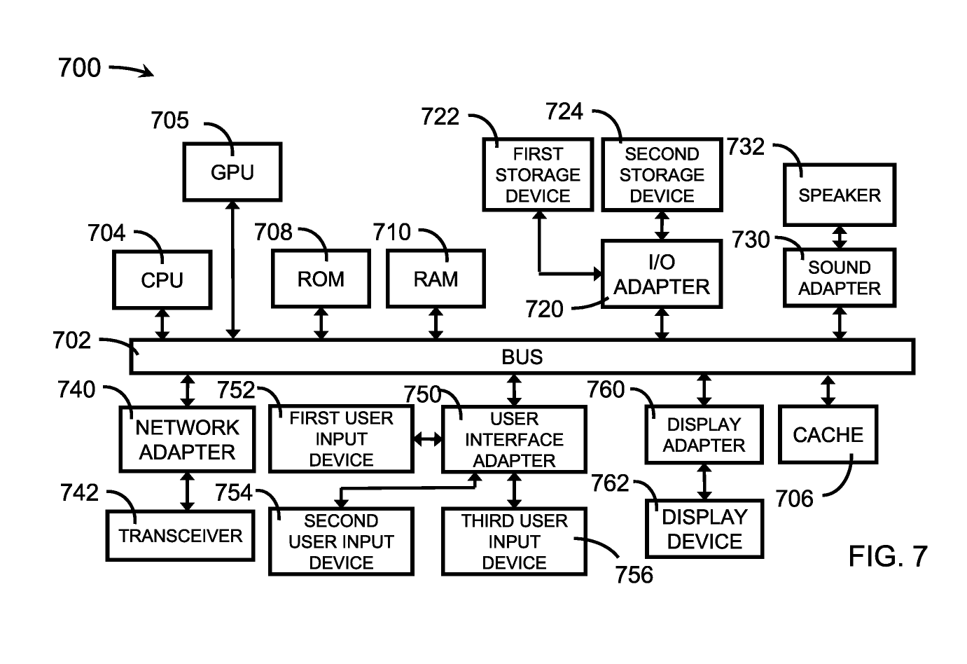

FIG. 7 is an exemplary processing system 700 to which the present methods and systems may be applied in accordance with another embodiment of the present invention. The processing system 700 can include at least one processor (CPU) 704 and at least on graphics processing (GPU) 705 that can perform vector calculations/manipulations operatively coupled to other components via a system bus 702. A cache 706, a Read Only Memory (ROM) 708, a Random Access Memory (RAM) 710, an input/output (I/O) adapter 720, a sound adapter 730, a network adapter 740, a user interface adapter 750, and a display adapter 760, are operatively coupled to the system bus 702.

A first storage device 722 and a second storage device 724 are operatively coupled to system bus 702 by the I/O adapter 720. The storage devices 722 and 724 can be any of a disk storage device (e.g., a magnetic or optical disk storage device), a solid state magnetic device, and so forth. The storage devices 722 and 724 can be the same type of storage device or different types of storage devices.

A speaker 732 is operatively coupled to system bus 702 by the sound adapter 230. A transceiver 742 is operatively coupled to system bus 702 by network adapter 740. A display device 762 is operatively coupled to system bus 702 by display adapter 760.

A first user input device 752, a second user input device 754, and a third user input device 756 are operatively coupled to system bus 702 by user interface adapter 750. The user input devices 752, 754, and 756 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 752, 754, and 756 can be the same type of user input device or different types of user input devices. The user input devices 752, 754, and 756 are used to input and output information to and from system 700.

Of course, the processing system 700 may also include other elements (not shown), as readily contemplated by one of skill in the art, as well as omit certain elements. For example, various other input devices and/or output devices can be included in processing system 700, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 700 are readily contemplated by one of ordinary skill in the art given the teachings of the present principles provided herein.

Moreover, it is to be appreciated that system 700 is a system for implementing respective embodiments of the present methods/systems. Part or all of processing system 700 may be implemented in one or more of the elements of FIGS. 1-6.

Further, it is to be appreciated that processing system 700 may perform at least part of the methods described herein including, for example, at least part of method 100 of FIG. 1 and method 600 of FIG. 6.

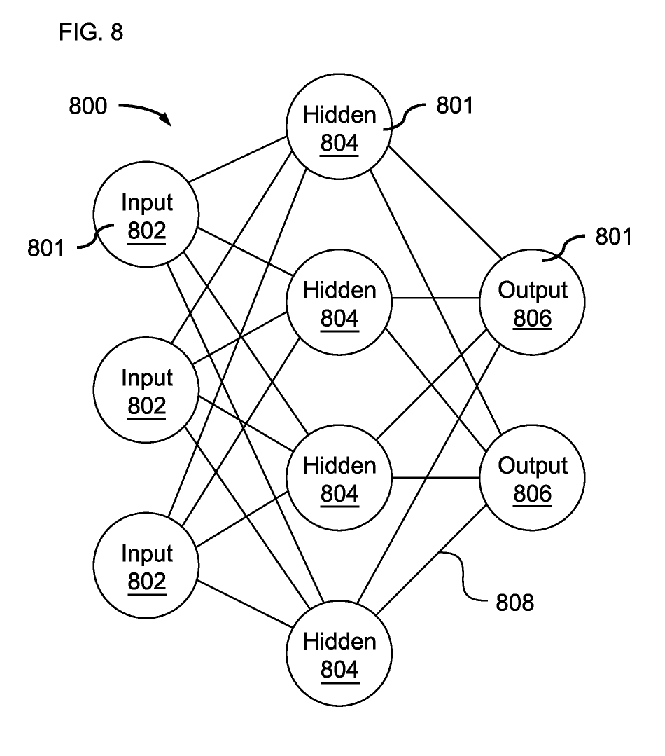

FIG. 8 is a block diagram illustratively depicting an exemplary neural network in accordance with another embodiment of the present invention.

A neural network 800 may include a plurality of neurons/nodes 801, and the nodes 808 may communicate using one or more of a plurality of connections 808. The neural network 800 may include a plurality of layers, including, for example, one or more input layers 802, one or more hidden layers 804, and one or more output layers 806. In one embodiment, nodes 801 at each layer may be employed to apply any function (e.g., input program, input data, etc.) to any previous layer to produce output, and the hidden layer 804 may be employed to transform inputs from the input layer (or any other layer) into output for nodes 801 at different levels.

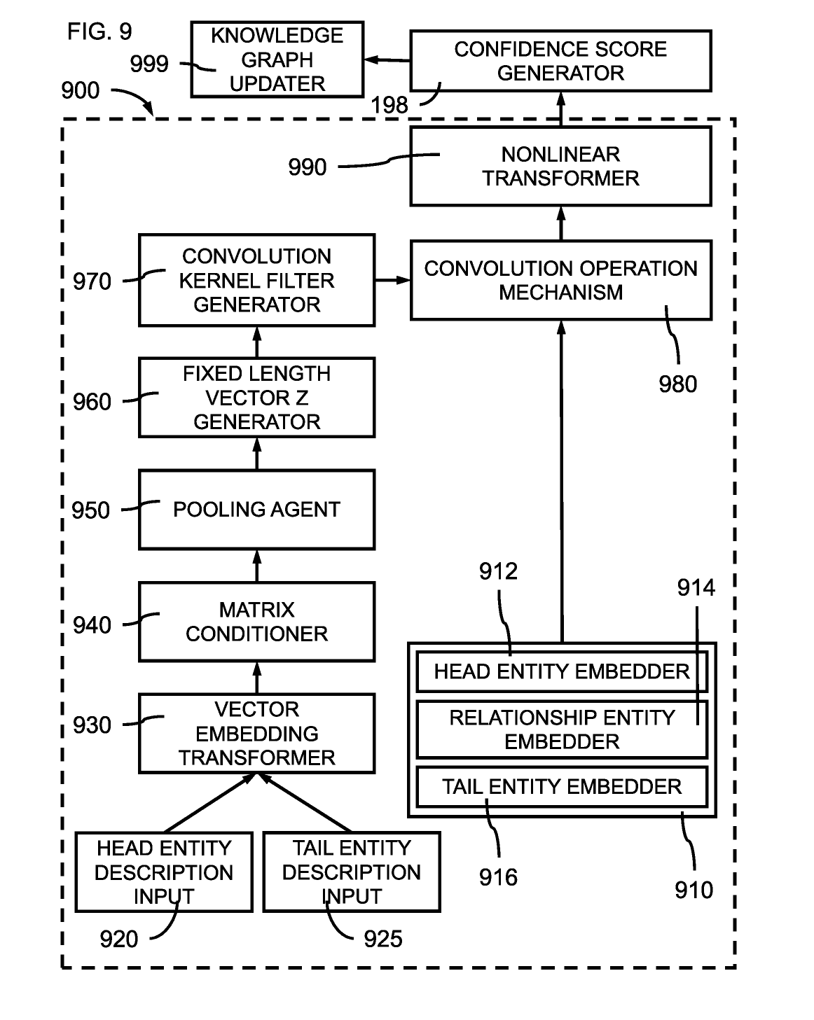

FIG. 9 is an exemplary processing system 900 to which the present methods and systems may be applied in accordance with another embodiment of the present invention.

In one or more embodiments, the methods/systems can be implemented as an ACNN processing system 900, where a processing system 700 can be configured to include an embedding mechanism 910 that can have a head entity embedder 912, a relationship entity embedder 914, and a tail entity embedder 916. The embedding mechanism 910 can be configured to perform an embedding operation on triplets (h, l, t), where the head entity embedder 912 can be configured to perform an embedding operation on a head entity, h, the relationship entity embedder 914 can be configured to perform an embedding operation on a relationship, l, and a tail entity embedder 916 can be configured to perform an embedding operation on a tail entity, t, although all embedding operations may be performed by a single embedding mechanism 910.

The system ACNN processing system 900 can be further configured to have a head entity description input 920 configured to receive and/or filter head entity descriptions obtained from a knowledge graph or knowledge base, and a tail entity description input 925 configured to receive and/or filter tail entity descriptions obtained from the knowledge graph or knowledge base.

The system ACNN processing system 900 can be further configured to have a vector embedding transformer 930 that is configured to embed partial triplets from the head entity description input 920 and the tail entity description input 925. The vector embedding transformer 930 can embedded as vectors the partial triplets identified in head entity description input 920 and the tail entity description input 925 for subsequent operations, where the vectors for the partial triples can be combined by the vector embedding transformer 930 into a combined matrix, m2.

The system ACNN processing system 900 can be further configured to have a matrix conditioner 940 that is configured to generate kernels and apply a convolution operation with ReLU over the matrix, m2. The matrix conditioner 940 can apply a filtering operation to the combined matrix, and generate c feature maps. The matrix conditioner 940 can be configured to apply a Rectified Linear Unit (ReLU) activation function, ReLU (x)=max (0, x) to the feature maps to get non-negative feature maps.

The system ACNN processing system 900 can be further configured to have a pooling agent 950 that is configured to use max-pooling over the feature maps to get subsamples. The pooling agent 950 can be configured to apply a pooling function to reduce the dimensions of the output from convolution matrix to obtain a feature map with a predetermined set of dimensions.

The system ACNN processing system 900 can be further configured to have a fixed length vector generator 960 that is configured to apply a linear mapping method for flattening the subsampling feature maps into a one-dimensional feature vector. The fixed length vector generator 960 can be further configured to map the feature vector, ƒ_{flat}, into a new fully connected feature, ƒ_{fc1}, where ƒ_{fc1}=ƒ_{flat} W_{flat}+b_{flat}, where W_{flat} is the linear mapping weight, and b_{flat} is the bias.

The system ACNN processing system 900 can be further configured to have a convolution kernel filter generator 970 that is configured to generate new convolution filters or new weights, and apply the new convolution filters or weights to the fully connected feature map. The convolution kernel filter generator 970 can be configured to use logistic regression to calculate scores and perform a final score function.

The system ACNN processing system 900 can be further configured to have a convolution operation mechanism 980 that is configured to apply convolution operations to the known head, relationship, tail triplets, (h, l, t).

The system ACNN processing system 900 can be further configured to have a nonlinear transformer 990 that is configured to use a loss function in producing an output score.

The system ACNN processing system 900 can be further configured to have a confidence score generator 998 that is configured to calculate confidence scores for output to a user.

The system ACNN processing system 900 can be further configured to incorporated back into a knowledge graph newly identified relationships that can improve the knowledge graph through a knowledge graph updater 999. The confidence scores from the confidence score generator 998 can be used to find missing or incorrect relationships in knowledge graphs and identify the most probable triplets, (h, l, t), which can be added into the knowledge graph to advance the knowledge graph completion.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for predicting new relationships in the knowledge graph, comprising:
embedding a partial triplet including a head entity description and a relationship or a tail entity description to produce a separate vector for each of the head, relationship, and tail;
combining the vectors for the head, relationship, and tail into a first matrix;
applying kernels generated from the entity descriptions to the matrix through convolutions to produce a second matrix having a different dimension from the first matrix;
applying an activation function to the second matrix to obtain non-negative feature maps;
using max-pooling over the feature maps to get subsamples;
generating a fixed length vector, Z, that flattens the subsampling feature maps into a feature vector; and
using a linear mapping method to map the feature vector into a prediction score.

2. The method as recited in claim 1, wherein the first matrix is a 3×k matrix, where k is the embedding dimensionality.

3. The method as recited in claim 2, wherein the kernel is a 3×3 matrix.

4. The method as recited in claim 3, wherein the activation function is a Rectified Linear Unit (ReLU).

5. The method as recited in claim 4, wherein the max pooling filter is set as (1×2) and the stride as 2.

6. The method as recited in claim 5, wherein the fully connected feature, ƒ_{fc1}=ƒ_{flat} W_{flat}+b_{flat}, where W_{flat} is the linear mapping weight, and b_{flat} is the bias.

7. The method as recited in claim 6, further comprising, applying max pooling and dropout to the fully connected feature, ƒ_{fc1}, to get a new fully connected feature map, ƒ_{fc2}.

8. A system for predicting new relationships in the knowledge graph, comprising:
a vector embedding transformer that is configured to embed partial triplets from the head entity description input and the tail entity description input, and combine the vectors for the partial triples into a combined matrix, m2;
a matrix conditioner that is configured to generate kernels and apply convolution operations with ReLU over the matrix, m2, to generate feature maps;
a pooling agent that is configured to use max-pooling over the feature maps to get subsamples that form subsampling feature maps;
a fixed length vector generator that is configured to apply a linear mapping method that flattens the subsampling feature map into a feature vector, and uses a linear mapping method to map the feature vector into a prediction score; and
a convolution kernel filter generator that is configured to generate new weights, and apply the new weights to the fully connected feature map.

9. The system as recited in claim 8, wherein the kernels are a 3×3 matrix.

10. The system as recited in claim 8, wherein the fully connected feature, ƒ_{fc1}=ƒ_{flat} W_{flat}+b_{flat}, where W_{flat} is the linear mapping weight, and b_{flat} is the bias.

11. The system as recited in claim 8, wherein the max pooling filter is set as (1×2) and the stride as 2.

12. The system as recited in claim 8, further comprising an embedding mechanism configured to perform an embedding operation on triplets (h, l, t).

13. The system as recited in claim 12, further comprising a convolution operation mechanism that is configured to apply convolution operations to the known head, relationship, tail triplets, (h, l, t).

14. The system as recited in claim 13, further comprising a nonlinear transformer that is configured to use a loss function in producing an output score.

15. A computer readable storage medium comprising a computer readable program for training a neural network to predict new relationships in the knowledge graph, wherein the computer readable program when executed on a computer causes the computer to perform the steps of:
embedding a partial triplet including a head entity description and a relationship or a tail entity description to produce a separate vector for each of the head, relationship, and tail;
combining the vectors for the head, relationship, and tail into a first matrix;
applying kernels generated from the entity descriptions to the matrix through convolutions to produce a second matrix having a different dimension from the first matrix;
applying an activation function to the second matrix to obtain a non-negative feature maps;
using max-pooling over the feature maps to get subsamples;
generating a fixed length vector, Z, that flattens the subsampling feature maps into a feature vector; and
using a linear mapping method to map the feature vector into a prediction score.

16. The computer readable storage medium comprising a computer readable program, as recited in claim 15, wherein the first matrix is a 3×k matrix, where k is the embedding dimensionality.

17. The computer readable storage medium comprising a computer readable program, as recited in claim 15, wherein the kernel is a 3×3 matrix.

18. The computer readable storage medium comprising a computer readable program, as recited in claim 15, wherein the activation function is a Rectified Linear Unit (ReLU).

19. The computer readable storage medium comprising a computer readable program, as recited in claim 15, wherein the max pooling filter is set as (1×2) and the stride as 2.

20. The computer readable storage medium comprising a computer readable program, as recited in claim 15, wherein the fully connected feature, ƒ_{fc1}=ƒ_{flat} W_{flat}+b_{flat}, where W_{flat} is the linear mapping weight, and b_{flat} is the bias.
